(19) United States
(12) Patent Application Publication
(10) Pub. No.: US 2015/0331936 A1
(43) Pub. Date: Nov. 19, 2015

(54) METHOD AND SYSTEM FOR EXTRACTING A PRODUCT AND CLASSIFYING TEXT-BASED ELECTRONIC DOCUMENTS

(71) Applicant: Faris ALQADAH, San Jose, CA (US)

(72) Inventor: Faris ALQADAH, San Jose, CA (US)

(21) Appl. No.: 14/712,683

(22) Filed: May 14, 2015

Related U.S. Application Data
(60) Provisional application No. 61/993,133, filed on May 14, 2014.

(51) Int. Cl. G06F 17/30; G06F 17/28

(52) U.S. Cl. CPC G06F 17/30705; G06F 17/30616; G06F 17/28

(57) ABSTRACT

A system to automatically enhance, tag, classify, categorize, cluster and index products described in unstructured text-based electronic documents. The system and method incorporate the use of text normalization, regular expressions, product number matching rules, text segmentation, entity detection, language models, predictive modeling, hierarchal subspace clustering, formal concept analysis, and a weighted combination of all techniques to detect and infer knowledge extracted from a digital version of raw, unstructured product text. Knowledge extracted and inferred comprises knowledge units including: main conceptual entity, entity text patterns, product language models, and conceptual hierarchies. The extracted knowledge units are utilized to store and index products in a product knowledge database and the products and knowledge units are made available to users via a user interface.

### RELATED APPLICATION

The present application claims priority from U.S. provisional patent application No. 61/993,133 entitled “KNOWLEDGE EXTRACTION” filed May 14, 2014, which is incorporated herein by reference in its entirety.

### BACKGROUND OF THE DISCLOSURE

The present disclosure generally relates to the field of natural language processing (NLP) and data mining and, more particularly, to a system and computer-implemented method of manipulation of unstructured product text to organize it into a searchable database.

### A. DESCRIPTION OF THE RELATED ART

Detailed product information is increasingly available on the World Wide Web (WWW) and on consumer shopping receipts. Extracting actionable first order knowledge units (e.g. price, quantity, quantity unit, brand, category) and second order knowledge units (e.g. hierarchal relationships between brands and product concepts, cross brand comparable products, price trend shifts, etc.) from these data sources would be a valuable resource. For example, such a method would be valuable to companies providing comparison shopping services, companies providing personal analytics or individual consumers conducting shopping research. Manually detecting such knowledge from large, heterogeneous and unstructured text sources is not practically reasonable or scalable. Consequently, there is a need for a system and a computer-implemented method for automatically, accurately, and efficiently extracting such knowledge units. This involves cleaning and enhancing the text, identifying entities (such main concepts, brands, quantities, price, quantity units, etc.), computing conceptual hierarchies from the first order knowledge units, and finally intelligently indexing all the knowledge units for efficient use and retrieval by users and other systems.

The following patent sources discuss the general background of the disclosure, and each one is incorporated herein by reference in its entirety:
1) US 2007/0067320 by Novak, published Mar. 22, 2007, for “Detecting Relationships in Unstructured Text;”
2) U.S. Pat. No. 8,549,039 by Seamon, published Oct. 1, 2013 for “Method and System for Categorizing Items in Both Actual and Virtual Categories;”
3) U.S. Pat. No. 8,396,864 by Harinarayan et al., published Mar. 12, 2013 for “Categorizing Documents;”
4) U.S. Pat. No. 8,086,592 by Mion et al., published Dec. 27, 2011 for “Apparatus and Method for Associating Unstructured Text with Structured Data;”
5) U.S. Pat. No. 7,853,549 by Scott et al., published Dec. 14, 2010 for “Systems and Methods for Automatically Categorizing Unstructured Text;”
6) EP 2545511 by Alibaba Group, published Jan. 16, 2013 for “Categorizing products.”

### SUMMARY OF THE DISCLOSURE

In view of the foregoing, embodiments of the disclosure provide a system and a computer implemented method of extracting actionable knowledge units from unstructured product text. The unstructured product text is enhanced and normalized by tagging, classifying, categorizing, and computing conceptual hierarchies from product text. In one embodiment, the extracted actionable knowledge units are processed to derive and structure relationships in a hierarchal fashion that are retrievably stored and indexed in a searchable products knowledge base.

### A. Cleaning and Enhancing

An embodiment of using a system of extracting actionable knowledge units in unstructured product text comprises first cleaning and enhancing the raw text to a normalized form. This is especially important in the case of product text extracted from receipts and OCR systems. For example, the raw product text may simply state: ssf 2% mlk. This is then enhanced and normalized to: Sunny Select Farms 2% Milk Techniques for cleaning or enhancing product text include: fuzzy string matching with various string distance measures to known product terms and brands at the token level, soundex matching to known product terms using multiple phonetic algorithms, term frequency statistics extracted from known product corpus, inverse document frequency statistics extracted from known product corpus, length of product term, position of individual terms in the text, abbreviation expansion rules derived from known corpus, neighboring tokens in a single product text, lowercase normalization, punctuation normalization and a machine learning ranking model to combine all of the previously mentioned approaches to select the best enhancement among all possible candidate enhancements. Minimal human labeling maybe utilized to mark correctly enhanced product text to create a feedback loop into the system and allow for automatic tuning of parameters for improved cleaning quality over time.

### B. Entity Detection

An embodiment of a system of extracting actionable knowledge units from product text identifies entities in the text following the cleaning and enhancing phase. At a minimum, the system identifies every word in the product as one of the following classes of entities: main concept, brand, descriptor, quantity, discrete quantity unit, continuous quantity unit, price, miscellaneous, etc. Techniques for entity detection from product text include, but are not limited to:
1) Segmenting each product text into tokens based on lexicons or dictionaries of known entity terms associated with each entity class. For example the product term: Sunnyside Farms 2% Milk could be segmented in the following tokens:
   a. Sunnyside Farms
   b. 2%
   c. Milk.
2) Extracting features or attributes associated with each token to be utilized in a Machine Learning or Conditional Random Field (CRF) algorithm.
3) A machine learning or CRF algorithm such as Support Vector Machines, Naïve Bayes, Random Forests, Gradient Boosting, CRF++, etc. to produce the final tagging of an entity class to each token.
4) A feedback loop to improve the entity detection over time. The feedback loop should include manual human labeling of product text with the correct text segmentation and entities following system predictions. In addition, external data sources such as online product catalogs, external product websites, public product databases, public government databases, and other available product data sources such as Wikipedia, DBPedia, etc. may be utilized to amend the dictionaries known entity terms.

### C. Concept Hierarchy Clustering

Text enhancement, cleaning, and entity detection typify a system extracting actionable first order knowledge units from raw product text. Deriving and structuring relationships in a hierarchal fashion between products, product concepts, product entities (for example: relationships between brands and main product concepts, relationships between main product concepts and descriptors, relationships between brands and product descriptors, relationships between brands, descriptors and main product concepts, etc.) exemplify a system that mines actionable second order knowledge units from raw product text. Second order knowledge units allows the system to answer questions like “What brands produce milk?”, “What brands produce 2% organic milk?”, “What are the different quantities that Berkley Farms produces chocolate milk in?”, etc. Methods for deriving and structuring such second order knowledge units include but are not limited to:
1. Concept matrix representations of products and derived entities that serve as input to data mining or unsupervised machine learning clustering algorithms. For example, one such representation could encompass representing the rows of the matrix as unique product texts and the columns as all possible unique text and/or derived entities. Every (i, j) entry of this matrix is set to 1 if the product text/entity in column j occurs in product text i and is set to 0 otherwise.
2. Computing similarity matrix representations from concept matrix representations utilizing similarity/dissimilarity measures such as: Euclidean Distance, Squared Euclidean Distance, Manhattan Distance, Maximum Distance, Cosine Similarity, Jaccard Coefficient, Dice Coefficient, Hamming Distance, Overlap coefficient, etc.
3. Hierarchal clustering algorithms such as: agglomerative clustering, divisive clustering, WARD clustering, max linkage, minimum linkage, average linkage, centroid linkage, minimum energy clustering etc. applied to a product similarity/dissimilarity matrix.
4. Dendogram representations to represent the clustering structure inferred by a hierarchal clustering algorithm.
5. Formal Concept Analysis data mining algorithms such as Bourdat, Nclu, etc. applied to a product concept matrix representation.
6. Concept lattice representations to represent conceptual clustering structure inferred by a Formal Concept Analysis mining algorithm.
7. Co-clustering, bi-clustering, and subspace clustering algorithms such as Spectral Co-clustering, Spectral Bi-clustering, etc. applied to a product concept matrix representation.
8. A weighted combination of all of the above mentioned techniques.
   D. Intelligent indexing

Upon deriving first order and second order knowledge units from unstructured product text, such knowledge units may be stored and indexed in a products knowledge base to enable efficient retrieval of the derived knowledge. In addition, such indexing can be implemented with the goal of facilitating efficient business intelligence analysis at varying levels of granularity across the collection of products and derived knowledge units. Indexing techniques include, but are not limited to:
1. Indexing products by every derived entity.
2. Indexing product number mappings to enhanced product text.
3. Indexing products by associated product concepts and reverse indexing product concepts by associated products.
4. Indexing products by inferred categories and reverse indexing inferred categories by associated products.

These and other aspects of embodiments of the invention will be better appreciated and understood when considered in conjunction with the following description and the accompanying drawings. It should be understood, however, that the following description, while indicating embodiments of the invention and numerous specific details thereof, is given by way of illustration and not of limitation. Many changes and modifications may be made within the scope of the embodiments of the description without departing from the spirit thereof, and the embodiments includes all such modifications.

### BRIEF DESCRIPTION OF THE DRAWINGS

FIG. 1 is a block diagram generally representing a computer system into which the present invention may be incorporated;

FIG. 2 is a schematic flow diagram of an embodiment of a system for detecting actionable knowledge in unstructured product text-based electronic documents, in accordance with an aspect of the present invention;

FIG. 3 is a block diagram generally representing an exemplary architecture of system components of an engine for cleaning and enhancing unstructured product text (UPT), which results in converting UPT to enhanced product text (EPT), in accordance with an aspect of the present invention;

FIG. 4 is a flow chart generally representing the steps undertaken in one embodiment of a method for detecting entities in an EPT, in accordance with an aspect of the present invention;

FIG. 5 is a flow chart generally representing the steps undertaken in one embodiment of a method for mining a conceptual hierarchy from a collection of EPT and associated first order knowledge units such as token segmentation and token entities, in accordance with an aspect of the present invention;

FIG. 6 is an illustration depicting an embodiment of a concept matrix and associated conceptual hierarchy derived from EPT collection paired with first order knowledge units such as token segmentation and token entities, in accordance with an aspect of the present invention;

FIG. 7 is a flow chart generally representing the steps undertaken in one embodiment of a method for inferring the main entity from EPT, in accordance with an aspect of the present invention.

### DETAILED DESCRIPTION OF PRESENTLY PREFERRED EMBODIMENTS OF THE DISCLOSURE

The embodiments of the disclosure and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the disclosure. The examples used herein are intended merely to facilitate an understanding of ways in which the embodiments of the disclosure may be practiced and to further enable those skilled in the art to practice the embodiments of the invention. Accordingly, the examples should not be construed as limiting the scope of the disclosure.

### I. Exemplary Operating System

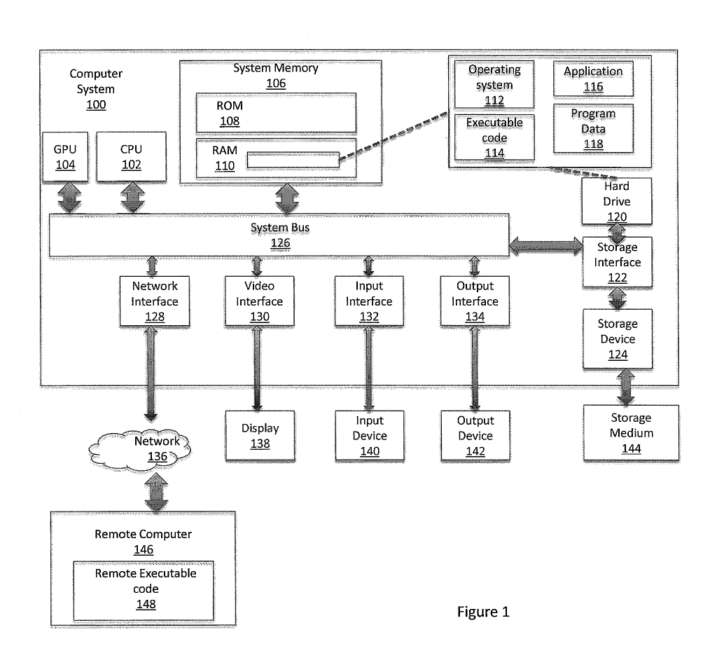

FIG. 1 is a block diagram generally representing a computer system and suitable components into which the present invention may fit. The embodiment is a singular example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The embodiments of the disclosure may be operational with numerous other general purpose or special purpose computing system environments or configurations.

The embodiments of the disclosure may be described in the general context of computer-executable instructions, such as program modules, being executed by a computer. Generally, program modules include routines, programs, objects, components, data structures, and so forth, which perform particular tasks or implement particular abstract data types or algorithms. The embodiments of the disclosure may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the embodiments of the disclosure may include a general-purpose computer system 100. Components of the computer system 100 may include, but are not limited to, a CPU or central processing unit 102, a graphical processing unit 104, a system memory 106, and a system bus 126 that connects several system components including the system memory 106 to the processing unit 102. The system bus 126 may be any of several types of bus structures including a memory bus or memory controller, a peripheral bus, and a local bus using any of a variety of bus architectures. The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 106 includes computer storage media in the form of volatile and/or nonvolatile memory such as read only memory (ROM) 108 and random access memory (RAM) 110. RAM 110 may contain operating system 112, application programs 116, other executable code 114 and program data 118. RAM 110 typically contains data and/or program modules that are immediately accessible to and/or presently being operated on by CPU 102.

Computer system 100 may also include other removable/non-removable, volatile/nonvolatile computer storage media. By way of example only, FIG. 1 illustrates a hard disk drive 120 that reads from or writes to non-removable, nonvolatile magnetic media, and storage device 124 that may be an optical disk drive or a magnetic disk drive that reads from or writes to a removable, a nonvolatile storage medium 144, such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. Hard disk drive 120 and storage device 124 may be typically connected to system bus 126 through an interface such as storage interface 122.

The drives and their associated computer storage media, discussed above and illustrated in FIG. 1, provide storage of computer-readable instructions, executable code, data structures, program modules and other data for computer system 100. In FIG. 1, for example, hard disk drive 120 is illustrated as storing operating system 112, application programs 116, other executable code 114 and program data 118. A user may enter commands and information into computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 132 that is coupled to the system bus, but may be connected by other interface and bus structures, such as a parallel port, game port or a universal serial bus (USB). A display 138 or other type of video device may also be connected to the system bus 126 via an interface, such as a video interface 130. In addition, an output device 142, such as speakers or a printer, may be connected to system bus 126 through an output interface 134 or the like.

Computer system 100 may operate in a networked environment using a network 136 to one or more remote computers, such as a remote computer 146. Remote computer 146 may be a personal computer, a server, a router, a network PC, a peer device or other common network node, and typically includes many or all of the elements described above relative to computer system 100.

Network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. The network connections shown are exemplary and other means of establishing a communications link between the computers may be used.

2. Extracting and Storing First Order and Second Order Knowledge Units from Unstructured Product Text

The present invention is generally directed towards a system and method for extracting and storing knowledge from unstructured product text (UPT). More specifically, the present invention may extract knowledge units describing products and relationships between products and stores such knowledge units such that a user or system may be able to access and utilize such knowledge units via a user interface (UI) or application program interface (API) respectively. As used herein, a knowledge unit means information that may describe any type of product including grocery products, housewares products, electronic products, etc. Knowledge units may include first order units extracted directly from UPT or second order knowledge units, which are inferred about single products from collections of UPT.

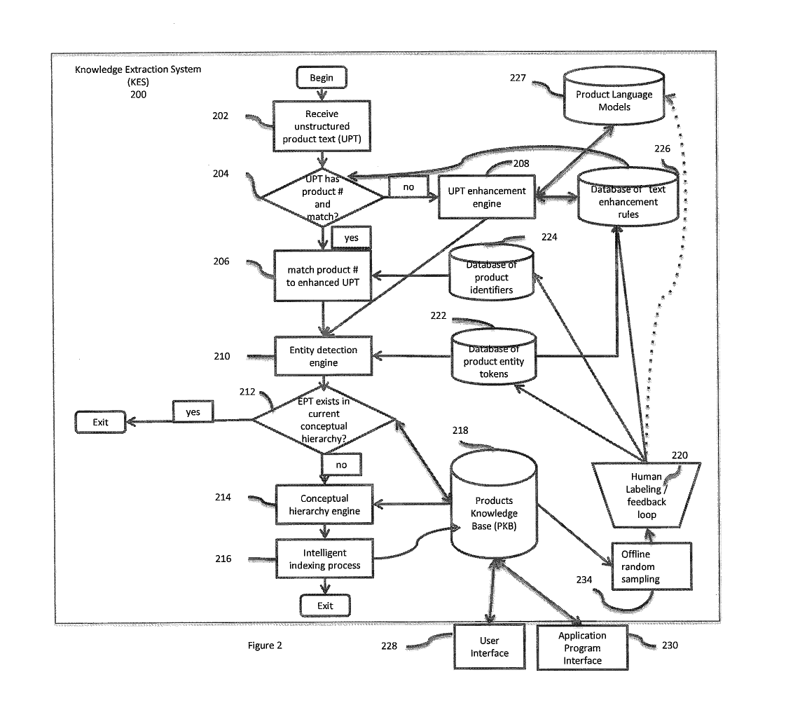

More particularly, referring to FIG. 2, an embodiment of a method of extracting actionable knowledge from UPT is disclosed. A knowledge extraction method 200 comprises a first step 202 of receiving a UPT as a digitally-stored text. The text is checked in step 204 to see if the UPT contains a product number, and if it does not using an UPT enhancement engine in step 208 to see if that product text matches an existing product found in a system's text enhancement database (TED) 226. Step 206, checking for a product number, may be accomplished by checking the UPT for text patterns that are representative of product numbers via a regular expression (e.g. Perl, Python, Ruby, etc. regular expressions). Product numbers refer to any type of product number including UPC (Universal Product Code), SKU (Stock Keeping Unit), and internal chain identification systems. Checking if enhanced product text matches an existing product in TED 226 may be executed via a database query to TED 226. TED 226 may be initialized in the system with manually input rules and augmented over time automatically via a UPT enhancement process 208 and manually by means of a manual human labeling feedback loop 220.

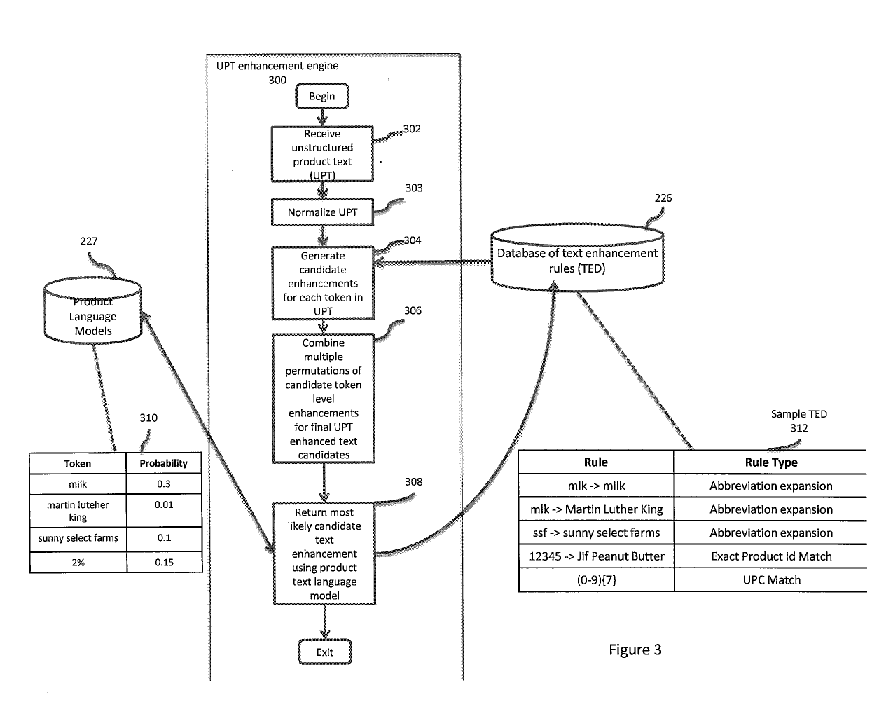

Referring to both FIGS. 2 and 3, an embodiment of the UPT enhancement process or engine 300 is depicted and can be understood. Enhancement engine 300 cleans, normalizes and enhances the UPT in order to facilitate further downstream processing in the knowledge extraction engine. An exemplary sample of product language models, stored in database 227 and an exemplary sample of rules stored in a text enhancement database 226 (TED) (FIG. 2), are depicted in table 310 and table 312, respectively. A more detailed embodiment of TED 226 and embodiments of its application are further detailed herein below.

Upon a determination in step 204 that an unstructured product text (UPT) received in step 202 does not have a product number match in TED 226, the UPT is fed into the UPT enhancement engine 208, This is reflected in the input of 300 in step 302.

Process 300 receives the UPT as a string input in step 302 and normalizes the string input in step 303. String normalization may include converting the UPT to a standard encoding (e.g. Unicode, ASCII, etc.), removing non-pertinent punctuation, removing excess whitespace, removing all capitalization, and removing non-pertinent symbols or characters. These steps produce a plurality of tokens. Every token of the UPT is scanned and checked in step 304 for matching a rule in TED database 304. If a matching rule is found for a token, then the enhancement rule is applied to the token and the resulting transformation maybe saved as a candidate transformation in step 304. This process is continued until all tokens in the UPT have been checked for possible enhancements in the TED. In this context, a token refers to a single 1-gram found within the UPT at minimum and could include up to n-grams at most, where an n-gram is defined as a contiguous sequence of n items from the given UPT). For example, the individual words or 1-grams within the UPT may be mapped to multiple enhancements.

Consider the UPT “ssf 2% mlk”. An enhancement process 304 checking for tokens up to 3-grams would check the following tokens for matching rules in TED 226:

ssf 2% mlk
2% mlk
ssf 2%
2% mlk
Ssf
2%
Mlk

Referring to the sample TED 312 the candidate enhancements would be the following:

| Token | Enhancement |
|---|---|
| Ssf | sunny side farms |
| Mlk | milk |
| Mlk | martin luther king |

TED 226, as depicted by way of example in table 312, contains abbreviation expansion rules, exact product matches and regular expressions to identify product identifiers. TED 226 may additionally contain more sophisticated rules, such as machine learning models, that utilize weighted combinations of rules in TED 226 and fuzzy string matching rules that use one or more weighted combinations of string distances, such as Edit distance, to infer candidate enhancements.

Subsequent to generating candidate enhancements, all the candidate enhancements may be combined and evaluated to select the most likely enhancements to be applied in order to produce a final enhanced product text (EPT) step 308. This process may utilize a product language model 227 to determine the most likely enhancement. The language model may be a unigram-gram, a factored, etc. language model that assigns a probability to a sequence of m words: P(w₁, . . . , wₘ) by means of a probability distribution. For example, referring to the sample language in table 310, the following candidate text enhancements would be scored:

| UPT | Candidate enhancement | Probability Score |
|---|---|---|
| ssf 2% mlk | sunnyside farms 2% milk | 0.0045 |
| ssf 2% mlk | Sunnyside farms 2% martin | 0.00045 |
| | luther king | |

The probability score may be computed from the sample language model in table 310 of FIG. 3 as follows:

P(enhanced text)=Π_{token in enhanced text}P(token).

For example, the three tokens that comprise the enhanced sample “sunny side farms 2% milk” have the following probabilities: 0.1 for “sunny side farms”; 0.15 for “2%”; and 0.3 for “milk”. Doing the multiplicand series, the probability of the enhanced sample is: (0.1)*(0.15)*(0.3)=0.00045. The initial probability distributions contained within the language model (table 310) may be initialized in the system by performing word counts from publically available product corpus (such as can be found on public websites like data.gov).

As can be seen, in this example the Unstructured Product Text (UPT) “ssf 2% milk” is enhanced to “sunnyside farms 2% milk” Enhanced Product Text (EPT) by the UPT enhancement engine 300.

In addition to returning the EPT to the main process 200 at the input to the entity detection engine of step 210, the UPT enhancement engine may also add this newly derived rule to TED 226 and update the probability language models 227 to form an automatic feedback loop. Manual human labeling may also be incorporated into this feedback loop to ensure quality. This process is depicted at the feedback loop step 220 in FIG. 2.

Referring back to FIG. 2, a UPT for which a matching product number was found in TED 208 may be enhanced using the match found by entity detection engine 210. Following conversion of UPT to EPT (via UPT enhancement engine 208 or id match process 210) the UPT system may now perform entity detection on the EPT 210. Entity detection entails tagging the tokens of the EPT to specific entity classes such as main, brand, price, descriptor, quantity, discrete quantity unit, continuous quantity unit, etc.

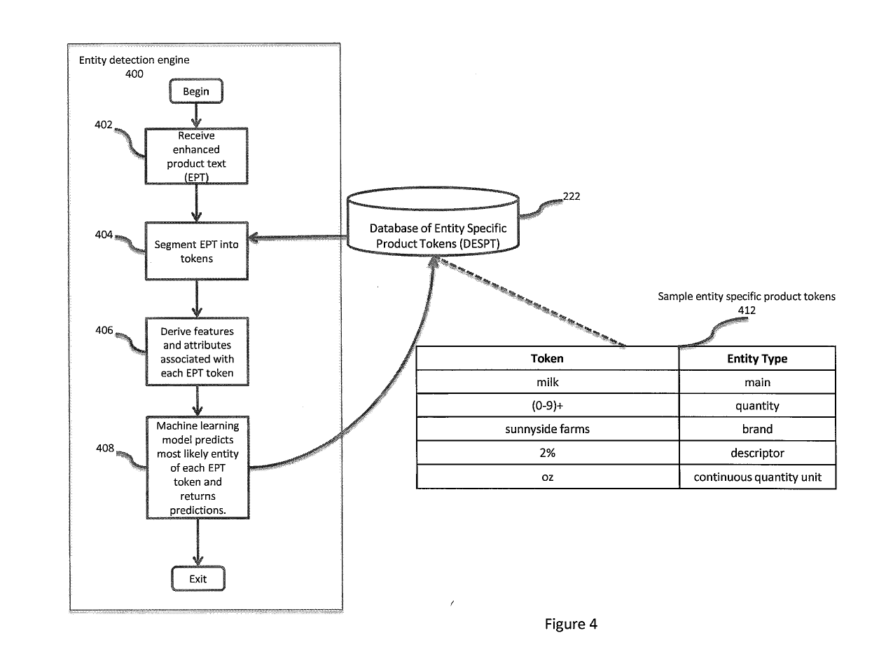

FIG. 4 depicts an embodiment of Entity Detection Process 400 (EDP 210 of FIG. 2). After receiving an EPT as a string in step 402, EDP 400 segments EPT into tokens in step 404 by scanning every n-gram in the EPT and checking for the matching of a rule in a Database of Entity Specific Product Tokens 222 (DESPT). DESPT 222 contains known token entity pairings and rules in the form of regular expressions and machine learning models that map known patterns to entities. This is shown in table 412 in FIG. 4. DESPT 222 can be initialized in the system with manually input rules, and can be augmented automatically over time via entity detection engine 408. DESPT 222 can also be manually augmented by means of a manual human labeling feedback loop 220. The engine may scan all EPT n-grams of varying cardinality n starting with largest value of n and decreasing to 1. On every scan, if a matching token is found then the n-gram is considered a segmented token of the EPT.

For example, consider the EPT: “sunnyside farms 2% milk”.

Applying the procedure described in the prequel and assuming DESPT contains an example data depicted in table 412 in FIG. 4, then the segmentation process results in the following:

| n | Token | match |
|---|---|---|
| 4 | sunnyside farms 2% milk | no |
| 3 | sunnyside farms 2% | no |
| 3 | farms 2% milk | no |
| 2 | sunnyside farms | yes |
| 2 | 2% milk | no |
| 1 | 2% | yes |
| 1 | milk | yes |

The resulting segmentation of the EPT is then

| Segment # | Token |
|---|---|
| 1 | sunnyside farms |
| 2 | 2% |
| 3 | milk |

Following segmentation the entity detection process 400 derives features or data attributes associated with each token 406. These features may relate to the EPT as a whole e.g.: bag of word features, the specific token, the relationship between the token and the entire EPT, or the relationship between the token and other tokens. The following table demonstrates an exemplary feature set and specific instantiation of this feature with respect to the token milk in the example EPT specified previously:

| Feature Name | Feature Type | EPT value |
|---|---|---|
| prev_token_contains_2% | Bag of words | Yes |
| #_characters_in_EPT | EPT feature | 24 |
| database_entity_token | Token feature | main |
| database_entity_prev_token | Token feature | descriptor |
| database_entity_nxt_token | Token feature | none |

The EPT Value of each feature in the previous table were derived as follows:
prev_token_contains_{—}2%: check if the token occurring before milk in the EPT contains the string “2%”.
#_characters_in_EPT: count to the total number of characters in the EPT.
database_entity _token: what is the entity of the token “milk” as defined by the database. In this case the value is “main” as is specified in 412.
database_entity prev_token: what is the entity of the previous token “2%” as defined by the database. In this case the value is “descriptor” as is specified in 412.
database_entity nxt_token: what is the entity of the next token “ ” as defined by the database. In this case the value is “none” since no next token exists.

The derived token features are utilized in conjunction with a machine-learning model to tag the token with the most likely entity type as listed in table 408. One such machine-learning algorithm is a Naïve-Bayes classifier, which classifies tokens as:

$$classify ( {f}_{1} , … , {f}_{n} ) = arg {max}_{c} p ( C = c ) {\prod }_{i = 1}^{n} p ( {F}_{i} = {f}_{i} \vert C = c )$$

where Fᵢ i=1, . . . , n are the token features and C is the set of entity types. The conditional probabilities (Fᵢ=fᵢ|C=c) maybe derived from DESPT 410. In addition to returning the tokens and entities derived from EPT to the main process 200, the entity detection process 400 may also update the DESPT 410 to form an automatic feedback loop. Manual human labeling may also be incorporated into this feedback loop to ensure quality. This process 232 is depicted in FIG. 2.

Referring again to FIG. 2, following entity detection in step 210, the system checks in a step 212 if the EPT and associated tokens and entity tags already exist in a Products Knowledge Base (PKB) 218. This may be accomplished via a database query. If the EPT does exist, then the product knowledge extraction process is complete as the first order knowledge units were extracted during the previous processes and the second order knowledge units already exist in the system.

On the other hand, if the EPT does not exist in the PKB, then the system computes the product conceptual hierarchy using the current EPT and all other EPTs stored in PKB 218. Generally, a product concept consists of a 2-way or equivalently bi-cluster or co-clustering of a collection of EPTs and their associated entities. A product concept hierarchy generally is an ordering or partial ordering relation of the product concepts. Defining or specifying product concepts is generally only possible with the availability of a matrix describing the relationship between individual EPTs in the EPT collection and the associated tokens and entities.

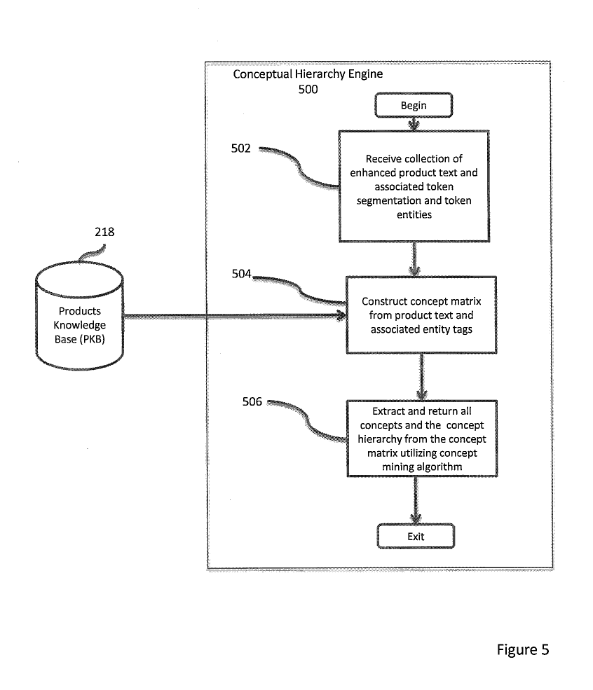

The conceptual hierarchy process or engine 500 is depicted in FIG. 5 and initially receives in step 502 the current EPT on which the knowledge extraction system is operating. Step 502 in addition also initially receives all other EPTs stored in the PKB 218, FIG. 2. A matrix representation of the EPT collection paired with associated tokens and entity tags is derived in step 504. The matrix representation is referred to as the concept matrix M. Concept matrix M may be constructed as follows:
1. Let the column labels of matrix M be the Cartesian product of all tokens and entity types in the DESPT 222. Refer to this enumerated set as J.
2. Let the row labels of matrix M be the set of EPTs currently in the knowledge base. Refer to this enumerated set as I.
3. The (i, j)th element of matrix M has a value of 1 if the i^{th} EPT in I contains the j^{th} token entity pair in J and has a value of 0 otherwise.

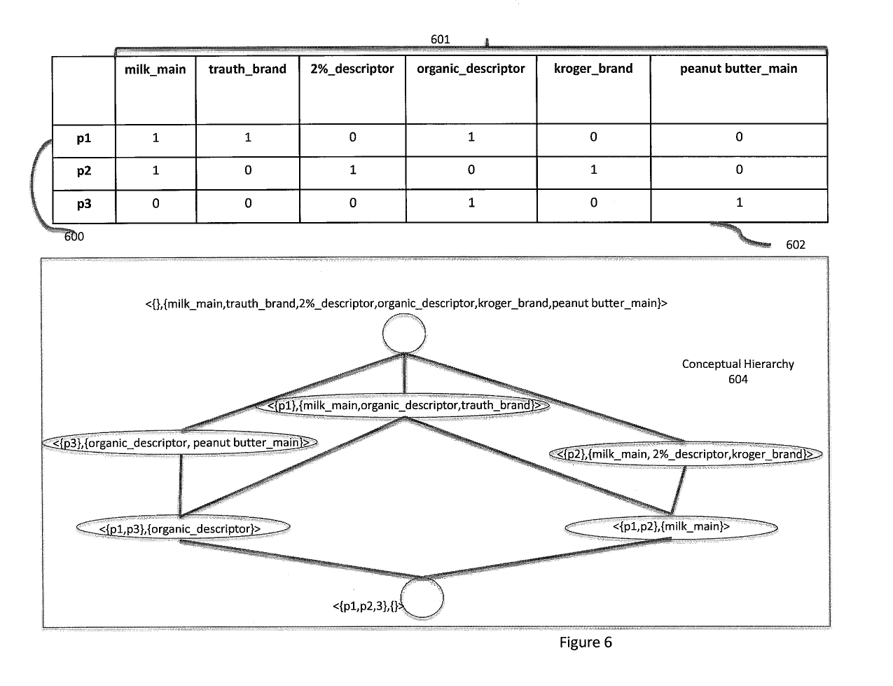

An exemplary illustration of a concept matrix construction 602 is depicted in FIG. 6. As can be seen the column labels 601 each consists of a token and entity type. It is possible that the same token will appear more than once as a column label with a different entity type pairing. The row labels 600 consist of unique EPT identifiers, while the cells of the matrix are populated with a 0 or 1 according the rules specified previously. Following construction of concept matrix M in step 504, the concept hierarchy process in step 506 extracts all the concepts and concept hierarchy from concept matrix M. One possible formulation of a product concept and product concept hierarchy from the product concept matrix is the Formal Concept Analysis formulation as follows:
1. Define A as a subset of the row labels of M. Formally, A⊂I
2. Define B as a subset of the column labels of M. Formally, B⊂J
3. Define Galois operators as:
   a. A′={jεJ|∀aεA M(a,j)=1};
   b. B′={iεI|∀bεB M(i,b)=1}.
4. Define a concept as a pair (A,B) such that
   a. A′=B
   b. B′=A
5. Concepts can be partially ordered by inclusion:
   a. Let (A₁, B₁) and (A₂, B₂) be concepts.
   b. Define partial ordering ≦ by stating that (A₁, B₁)≦(A₂, B₂) whenever A₁⊂A₂
6. Using the partial ordering defined in 5, a complete lattice of concepts maybe formulated; this is referred to as a conceptual hierarchy.

An exemplary illustration of the preceding concept and conceptual hierarchy formulation is depicted in FIG. 6 at 604. The exemplary concepts are derived from the exemplary concept matrix 602 and are depicted as ovals. Enumerating the concepts and conceptual hierarchy from a concept matrix may be achieved utilizing several Concept Mining algorithms such as CHARM, Bourdat, or NClu. Product concepts and conceptual hierarchies entail second order knowledge units derived from unstructured product text.

Referring again to FIG. 2, following the conceptual hierarchy process 214, in step 216 the UPT knowledge extraction system inserts and indexes all UPT into PKB 218 utilizing the first order and second order knowledge units extracted. This includes
1. Indexing products by detected entity.
2. Indexing product number mappings to enhanced product text.
3. Indexing products by associated product concepts and reverse indexing product concepts by associated products.
4. Indexing products by inferred main entities and reverse indexing inferred main entities by associated products.

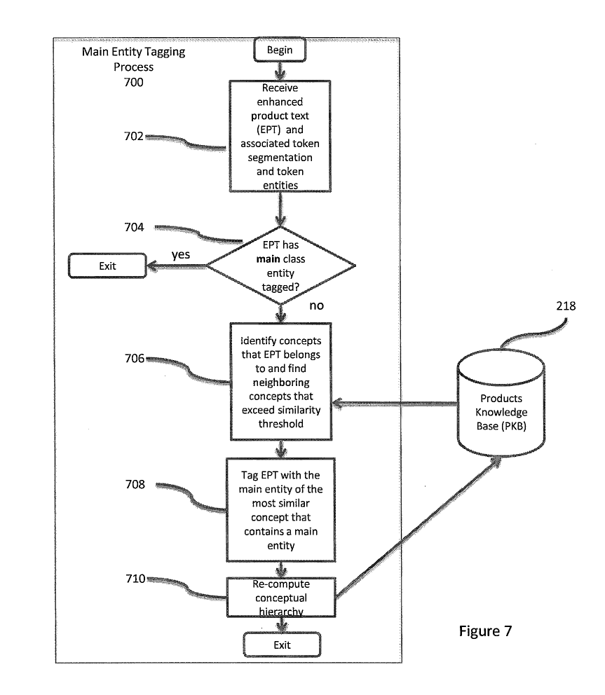

Inferring main entities for UPT that the system was unable to infer up to this point, may be included in an embodiment of an intelligent indexing process 700, as shown in FIG. 7. The process receives in step 702 an EPT, associated token segmentation, and token entities and assumes that the EPT exists in the PKB 702. If the EPT already contains a main entity as determined in step 704, then the process terminates. On the other hand, if a main entity has not been detected for the EPT, then all concepts which contain the EPT are retrieved from the PKB via a query 706. Neighboring concepts to the EPT concepts are identified via the concept hierarchy.

Let X be the set of concepts containing the EPT, and Y be the set of neighboring concepts to all concepts X. Then the most similar concept pair ((A₁, B₁), εX, (A₂, B₂)εY) may be identified utilizing concept similarity measures such as weighted concept similarity:

$$s ( ( {A}_{1} , {B}_{1} ) , ( {A}_{2} , {B}_{2} ) ) = w * \frac{\vert {A}_{1} ⋂ {A}_{2} \vert}{\vert {A}_{1} ⋃ {A}_{2} \vert} + ( 1 - w ) * \frac{\vert {B}_{1} ⋂ {B}_{2} \vert}{\vert {B}_{1} ⋃ {B}_{2} \vert}$$

where 0≦w≦1 and (A₁, B₁) and (A₂, B₂) are concepts. Following identification of the most similar concept pair, ((A₁, B₁), εX, (A₂, B₂)εY), if (A₂, B₂) contains a main entity tag, then in step 708 the process tags the original EPT with this main entity. Subsequent to this tagging, concept matrix M is modified in step 710 to reflect the additional tagging and the conceptual hierarchy is recomputed and stored in PKB 218.

Returning to FIG. 2, knowledge extraction system 200 may also entail a feedback loop 232 to ensure the improvement of performance over time. This may involve an offline random sampling as in a process 234 of PKB 218 and retrieving entity classifications, UPT enhancements, and collections of EPTs. Through human labeling in an input step 220, entity misclassifications, UPT mismatches, and erroneous UPT enhancements maybe identified and corrected, and reinserted into knowledge extraction system 200 as enhancement rules in database of text enhancement rules 226, product language probabilities in a product language models database 227, product identifier mappings in a database of product identifies 224, and product token entity pairs in a database of product entity tokens 222. The feedback loop may be enhanced via intelligent sampling when conducting human labeling in input 220 to focus on instances of text enhancement and entity prediction where the system has lower confidence intervals of success.

The first and second order knowledge units extracted by Knowledge Extraction System (KES) 200 may be accessed and utilized by applications, users, or other knowledge bases. Accessing these knowledge units may be conducted through a user interface (UI) 228 or Application Programming Interface (API) 230. The knowledge captured by the knowledge extraction system may be utilized to answer questions and provide insights via the UI or API. Examples of such questions and insights that the system can provide include, but not limited to, the following:
What is the price of particular product, type of product or product concept now, or historically?
What brands produce what type of products
What quantities are associated with specific product types?
What is the main entity or category of a particular product?
For a given product, what other products are conceptually or semantically similar.

As can be seen from the foregoing detailed description and the drawings, the present invention provides an improved system and method for extracting actionable knowledge from unstructured product text. The system and method may apply broadly to deriving and indexing knowledge for any type of unstructured product text originating from the WWW, OCR systems, or human input. Such a system and method may efficiently mine knowledge belonging to large and heterogeneous collections of product text. As a result, the system and method provide significant advantages and benefits needed in contemporary computing and in online and mobile applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

1. A method of using a computer system for extraction of information from unstructured product text, comprising:
searching an unstructured product text to identify and extract a product identifier;
checking for a match of the product identifier in a database of the system's knowledge;
enhancing the product text for further processing;
tagging tokens in the product text with different entity tags;
mining product concepts and computing a hierarchy of product concepts in the product text;
retrievably storing the information extracted from the product text into a database;
using a feedback loop to provide improved performance over time; and
using a mechanism to interface with the data base via an interface.

2. The method for extracting information from unstructured product text as claimed in claim 1 wherein said enhancing step includes selecting tokens from the product text and normalizing said tokens.

3. The method of using a computer system for extracting information from unstructured product text as claimed in claim 3 wherein said enhancing step further includes providing a text enhancement database that stores rules for enhancing the product text, and looking up stored rules to said tokens in order to generate text transformations.

4. The method of using a computer system for extracting information from unstructured product text as claimed in claim 3 and further comprising storing a products language model and using said model to compute the most likely combination of text transformations that adhere to the product language.

5. The method of using a computer system for extracting information from unstructured product text as claimed in claim 3, and further comprising using a feedback loop to improve said text enhancement database and a products language model over time by augmenting rules and re-computing token probabilities.

6. The method of using a computer system for extracting information from unstructured product text as claimed in claim 1, and further comprising segmenting the product text into tokens, deriving numerical features associated with each token, and tagging each said token with an entity tags including brand, quantity, and price, and tagging each token with the most likely entity tag.

7. The method of using a computer system for extracting information from unstructured product text as claimed in claim 6, and further comprising providing a database of entity specific tokens and rules and segmenting product text into appropriate tokens or an n-gram of words by matching varying subsets of the product text to the stored rules.

8. The method of using a computer system for extracting information from unstructured product text as claimed in claim 7, and further comprising deriving and associating a vector of numerical features with each token segment by computing statistics related to the token itself, neighboring tokens, and the product text as a whole.

9. The method of using a computer system for extracting information from unstructured product text as claimed in claim 7, and further comprising tagging each token in said product text with a most likely entity tag by computing the likelihood of each entity tag based on said associated vector.

10. The method of using a computer system for extracting information from unstructured product text as claimed in claim 1, and further comprising using a feedback loop to improve the entity specific tokens database over time by augmenting rules based on the output of a machine learning model and retraining said machine learning model according to the augmented rules.

11. The method of using a computer system for extracting information from unstructured product text as claimed in claim 1, and further comprising collecting product text, identifying concepts from said collections of product text and further organizing such concepts into a conceptual hierarchy.

12. The method of using a computer system for extracting information from unstructured product text as claimed in claim 11, and further comprising representing a collection of product text, associated text segments, and tagged entities as a numerical concept matrix and applying data mining clustering algorithms to said product collection.

13. The method of using a computer system for extracting information from unstructured product text as claimed in claim 12, and further comprising providing a concept matrix and identifying concepts and a concept hierarchy from said concept matrix by applying data mining clustering algorithms and storing the results in a database.

14. The method of using a computer system for extracting information from unstructured product text as claimed in claim 12, and further comprising storing, indexing and reverse indexing product tokens, segments, entity tags, concepts, and conceptual hierarchy in a database.

15. The method of using a computer system for extracting information from unstructured product text as claimed in claim 14, and further comprising determining if a product text unit has an associated main entity tag and if in the unit does not have one computing a conceptual hierarchy based on a leveraging conceptual hierarchy as computed by data mining similarity measures to infer the main entity of the product from conceptually similar products and tagging the unit.

16. The method of using a computer system for extracting information from unstructured product text as claimed in claim 14, and further comprising using a feedback loop for improving performance of said system over time by sampling said knowledge base and performing a human labeling in order to correct errors, enhance product text, manually derive entities, manually derive product identifiers, manually compose rules for entity tagging, manually compose rules for text enhancement and inserting labels human labels into said system.

17. A computer system for extraction of knowledge from unstructured product text, comprising:
a computer processor;
a product number identification processor to check for matches of the product in the system's knowledgebase;
a text enhancement engine which enhances product text for further processing;
an entity detection engine for tagging tokens in the product text with different entity tags;
a conceptual hierarchy engine for mining product concepts and computing a hierarchy of product concepts;
an intelligent indexing engine to store and facilitate effective and efficient storage and retrieval of all knowledge extracted from product text into a knowledge base;
a feedback loop mechanism to ensure improved performance of the system over time; and
a mechanism to interface with the knowledge base via an interface.

18. The computer system as claimed in claim 17 further comprising:
a product number identification process for detecting various types of product identifiers by applying product number identification rules.

19. The computer system as claimed in claim 17 further comprising:
an unstructured product text enhancement engine for enhancing product text for further downstream processing by normalizing the text, for applying several text transformations or enhancements to the tokens of the product text and for selecting the most likely combination of transformations that adhere to a product language.

20. The computer system as claimed in claim 17 in which said entity detection engine is for tagging tokens in the product text with different entity tags such as brand, quantity, price by segmenting the product text into tokens, deriving numerical features associated with each token and utilizing a machine learning algorithm to tag each token with the most likely entity.
